(19) United States
(12) Patent Application Publication
(10) Pub. No.: US 2010/0259939 A1
(43) Pub. Date: Oct. 14, 2010

(54) BRIGHTNESS ENHANCEMENT FILM HAVING COMPOSITE LENS AND PRISM STRUCTURE

(75) Inventors: Chi-feng Chen, Sinwu (TW); Jauh-jung Yang, Sinwu (TW)

Correspondence Address: AUSTIN RAPP & HARDMAN, 170 South Main Street, Suite 735, SALT LAKE CITY, UT, 84101, US

(73) Assignee: DAYU optoelectronics, Sinwu Township (TW)

(21) Appl. No.: 12/625,455

(22) Filed: Nov. 24, 2009

(30) Foreign Application Priority Data
Apr. 14, 2009 (TW) 098112409

(51) Int. Cl. F21V 5/02

(52) U.S. Cl. 362/340; 362/339

(57) ABSTRACT

A brightness enhancement film having a composite lens and prism structure is described. The brightness enhancement film having a composite lens and prism structure includes a substrate layer and a composite structure layer. The substrate layer has an optical incident surface and an optical emission surface. The composite structure layer is positioned on the optical emission surface of the substrate layer and has a lens-type layer and a prism-type layer. The lens-type layer has a plurality of protrusion units and the prism-type layer has a plurality of prismatic units. The protrusion units are uniformly arranged among the prismatic units. An area ratio of the region of the protrusion units to the region of the prismatic units based on a predetermined unit area of the composite structure layer can be changed for adjusting a convergent angle when a light beam penetrates through the composite structure layer via the optical emission surface of the substrate layer.

### CLAIM OF PRIORITY

This application claims priority to Taiwanese Patent Application No. 098112409, filed on Apr. 14, 2009.

### FIELD OF THE INVENTION

The present invention relates to a brightness enhancement film (BEF), and more particularly to the BEF having a composite lens and prism structure, wherein a composite structure is formed by a lens layer and a prism layer to improve moire pattern, light leakage, rainbow pattern, dark lines, and frictional scratches, and precisely adjusts the distribution of convergent angle when the light beam penetrates the BEF.

### BACKGROUND OF THE INVENTION

Conventionally, a brightness enhancement film (BEF) is widely used in a light module to concentrate a light beam from a light source on the user direction for the purpose of luminance increment along the visual filed of the user. The BEF composed of prisms is applicable to the display monitor to meet the requirement for higher luminance or to the display supplied with a battery set for the power saving. Such an application attempts to reuse the light outside the visual angle of the user by reflecting the light beam along the user direction in order to increase the usage efficiency of the light source so that the purpose of higher luminance and power saving are achieved.

However, the BEF is only composed of prism for centralizing the light beam and the prism sheets are arranged by an array of prisms in single direction. Thus, the concentrated light is not symmetrical. That is, the convergent angle parallel to the prism array (named as horizontal direction) is greater than the convergent angle perpendicular to the prism array (named as vertical direction). To solve the above problem, two BEFs having prism sheets are overlapped each other in a perpendicular type, thereby resulting in increasing the manufacturing cost. In addition, since the arrangements of the array prisms are regular and monotone, the problems of moire pattern, rainbow pattern, and dark lines occur. Further, the height of each prism from bottom to top is the same. Thus, moisture accumulated in the recess between two prisms is adsorbed to the components or material layer thereon. Therefore, the BEF is failure due to light leakage when the light penetrates through the prisms.

In another conventional case, the BEF is only composed of micro-lenses which are in axial symmetry status for each. Thus, the concentrated light through the micro-lenses are fixedly symmetrical. The convergent angle for the light distribution along the horizontal direction is too smaller, thereby resulting in no design flexibility for the BEF, which cannot meet the requirement of display standards of the light module used in monitor and television. Consequently, there is a need to develop the BEF for solving the aforementioned problems.

### SUMMARY OF THE INVENTION

The first objective of the present invention is to provide a brightness enhancement film (BEF) having a composite lens and prism structure to improve the moire pattern, light leakage, rainbow pattern, dark lines, and frictional scratches.

The second objective of the present invention is to provide the BEF having a composite lens and prism structure for effectively integrating the BEF to reduce material layers of the BEF for saving the manufacturing cost.

The third objective of the present invention is to provide the BEF having a composite lens and prism structure to precisely adjust the distribution of convergent angle when the light beam penetrates the BEF.

According to the above objectives, the present invention sets forth the BEF having a composite lens and prism structure. The brightness enhancement film having a composite lens and prism structure includes a substrate layer and a composite structure layer. The substrate layer has an optical incident surface and an optical emission surface. The composite structure layer is positioned on the optical emission surface of the substrate layer and has a lens-type layer and a prism-type layer. The lens-type layer has a plurality of protrusion units and the prism-type layer has a plurality of prismatic units. The protrusion units are uniformly arranged among the prismatic units. An area ratio of the region of the protrusion units to the region of the prismatic units based on a predetermined unit area of the composite structure layer can be changed for adjusting a convergent angle when a light beam penetrates through the composite structure layer via the optical emission surface of the substrate layer.

In one embodiment, the protrusion units of the lens-type layer are uniformly arranged among the prismatic units of the prism-type layer in an irregular status. The irregular status means that the protrusion units are haphazardly distributed among the prismatic units. In other words, the protrusion units have random arrangement intensity. For example, the arrangement between the protrusion units and the prismatic units is non-repetitive. In another embodiment, the protrusion units of the lens-type layer are uniformly arranged among the prismatic units of the prism-type layer in a regular status. The regular status means that the protrusion units are uniformly distributed among the prismatic units, wherein the protrusion units and the prismatic units may be regular or irregular shape for manufacturing their shapes, such as using a cutting process.

Specifically, the area ratio of the region of the protrusion units to the region of the prismatic units is either equal to or greater than one so that the total region of the protrusion units are either equal to or greater than the total region of the prismatic units on the substrate layer.

According to the above-mentioned descriptions, the protrusion units are uniformly arranged among the prismatic units, and an area ratio of the region of the protrusion units to the region of the prismatic units based on a predetermined unit area of the composite structure layer can be changed for adjusting an convergent angle when a light beam penetrates through the composite structure layer. Therefore, the problems of moire pattern, rainbow pattern, and dark lines are solved.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a schematic view of protrusion units having semi-circular spheroids on the lens-type layer according to a first embodiment of the present invention;

FIG. 1B is a schematic view of protrusion units having semi-oval spheroids on the lens-type layer according to a second embodiment of the present invention;

FIG. 1C is a schematic view of protrusion units having semi-cone spheroids on the lens-type layer according to a third embodiment of the present invention;

FIG. 1D is a schematic view of a prism-type layer having a plurality of prismatic units according to one embodiment of the present invention;

FIG. 2 is a schematic cross-sectional view of a composite structure layer having a lens-type layer and a prism-type layer according to one embodiment of the present invention;

FIG. 3A is a schematic plan view of a composite structure layer having a lens-type layer and a prism-type layer according to a first embodiment of the present invention;

FIG. 3B is a schematic plan view of a composite structure layer having a lens-type layer and a prism-type layer according to a second embodiment of the present invention;

FIG. 3C is a schematic plan view of a composite structure layer having a lens-type layer and a prism-type layer according to a third embodiment of the present invention;

FIG. 4 is a schematic waveform of brightness percentage to convergent angle along the vertical direction of the composite structure layer according to one embodiment of the present invention;

FIG. 5 is a schematic waveform of brightness percentage to convergent angle along the horizontal direction of the composite structure layer according to one embodiment of the present invention; and

FIG. 6 is a schematic waveform of average brightness of the composite structure layer having a lens-type layer and a prism-type layer according to one embodiment of the present invention.

### DETAILED DESCRIPTION OF THE PREFERRED EMBODIMENTS

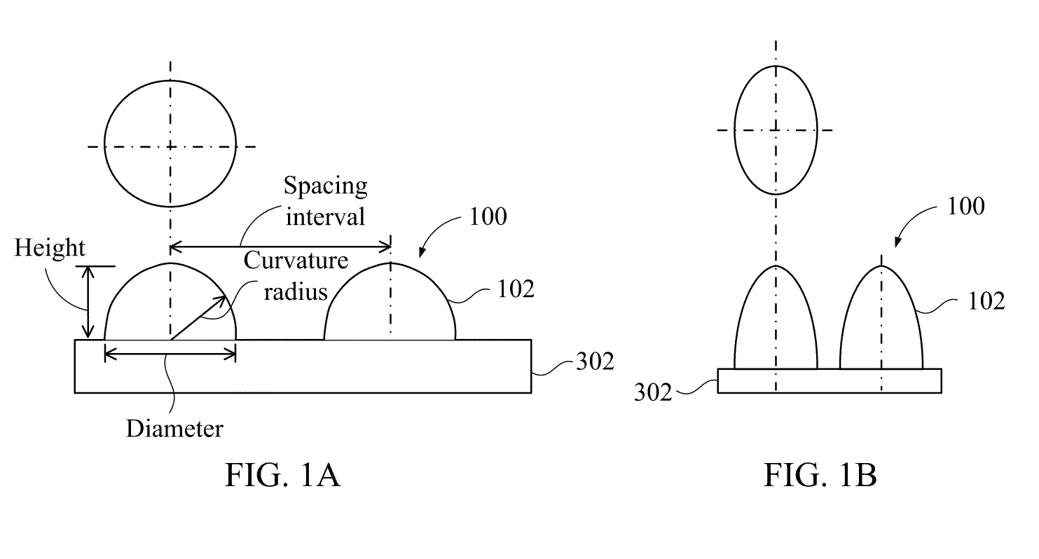

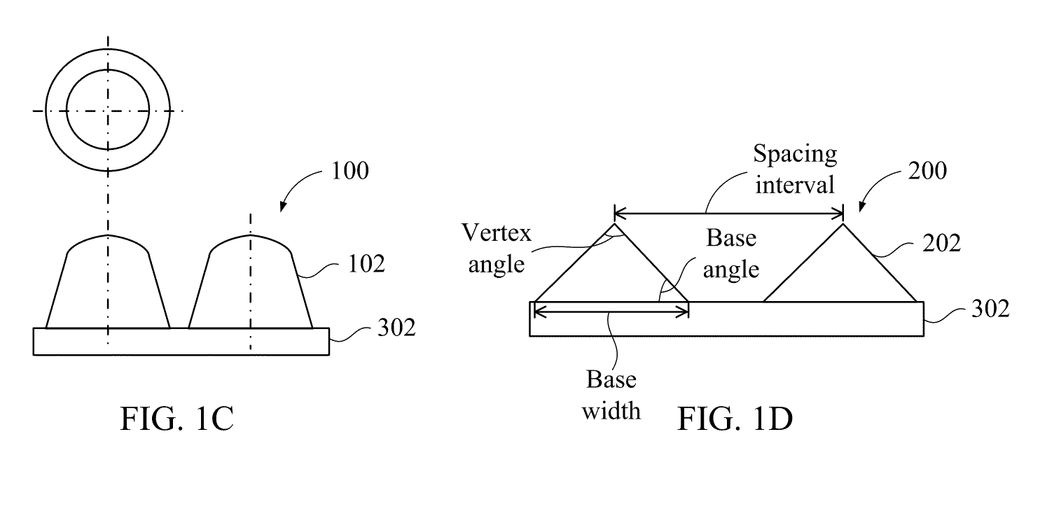

Please refer to FIG. 1A. It shows a schematic view of protrusion units 102 having semi-circular spheroids on the lens-type layer 100 according to a first embodiment of the present invention. Each of the protrusion units 102 of the lens-type layer 100 on the substrate layer 302 is an arc-shaped solid body with arbitrary curvature radius, e.g. a semi-circular spheroid. The bottom portion of the protrusion unit 102 may be defined as the size of diameter. That is, the cross-section of the protrusion unit 102 on the substrate layer 302 is circular, for example. Each of the protrusion units 102 further includes a height and curvature radius. Thus, the diameter, height and the curvature radius of the protrusion unit 102 can be modified to form the protrusion unit 102 with various geometric shapes. Each of the protrusion units 102 has a spacing interval therebetween for randomly arranging the protrusion units 102. The spacing interval can be changed to adjust the arrangement intensity of the protrusion units 102 of the lens-type layer 100 on the substrate layer 302. It should be noted that the semi-circular spheroids are connected together or overlapped partly. In one embodiment, the spacing interval has a range from 50 μm to 120 μm or arbitrary size. Preferably, the spacing interval has a range from 85 μm to 100 μm.

FIG. 1B is a schematic view of protrusion units 102 having semi-oval spheroids on the lens-type layer 100 according to a second embodiment of the present invention. Each of the protrusion units 102 of the lens-type layer 100 on the substrate layer 302 is a semi-oval spheroid with an axial asymmetry status. The cross-section of the protrusion unit 102 on the substrate layer 302 is oval, for example. The height and axial lengths of semi-oval spheroid can be modified to form the protrusion unit 102 with various geometric shapes. Each of the protrusion units 102 has a spacing interval therebetween for randomly arranging the protrusion units 102. The spacing interval can be changed to adjust the arrangement intensity of the protrusion units 102 of the lens-type layer 100 on the substrate layer 302. It should be noted that the semi-oval spheroids are connected together or overlapped partly.

FIG. 1C is a schematic view of protrusion units 102 having semi-cone spheroids on the lens-type layer 100 according to a third embodiment of the present invention. Each of the protrusion units 102 of the lens-type layer 100 on the substrate layer 302 is a semi-cone spheroid with an axial symmetry or asymmetry status. The cross-section of the protrusion unit 102 on the substrate layer 302 is circular, for example. The height and axial radius of semi-cone spheroid on the substrate layer 302 can be modified to form the protrusion unit 102 with various geometric shapes. Each of the protrusion units 102 has a spacing interval therebetween for randomly arranging the protrusion units 102. The spacing interval can be changed to adjust the arrangement intensity of the protrusion units 102 of the lens-type layer 100 on the substrate layer 302. It should be noted that the semi-oval spheroids are connected together or overlapped partly. The top region of the semi-cone spheroid 102 has a smooth surface to avoid frictional scratches when the semi-cone spheroid 102 contacts a material layer or component.

FIG. 1D is a schematic view of a prism-type layer 200 having a plurality of prismatic units 202 according to one embodiment of the present invention. Each of the prismatic units 202 of the prism-type layer 200 is prismatic geometry, e.g. triangular shape. The bottom portion of the prismatic unit 202 is defined as a base width having two base angles on the edge, and the top portion of the prismatic unit 202 is defined as a vertex angle. Thus, the base width, base angle and the vertex angle of the prismatic unit 202 can be modified to form the prismatic unit 202 with various geometric shapes. Each of the prismatic unit 202 has a spacing interval therebetween for randomly arranging the prismatic units 202. The spacing interval can be changed to adjust the arrangement intensity of the prismatic units 202 of the prism-type layer 200 on the substrate layer 302.

The prismatic units 202 of the prism-type layer 200 are a plurality of three-dimensional structure by dragging a plurality of prismatic cross-sections along the substrate layer 302 thereon. That is, the prismatic cross-sections are dragged along a path, e.g. straight and/or curve lines to generate the prism-type layer 200. In one embodiment, the prismatic cross-section is selected from a triangular shape, a semi-circular shape, a semi-oval shape, and a semi-cone shape. The semi-circular shape, semi-oval shape, and semi-cone shape are similar to the shapes shown in FIGS. 1A-1C. In one embodiment, the base width of prismatic unit 202 has a range from 10 μm to 80 μm or arbitrary size. Preferably, the base width has a range from 20 μm to 50 μm.

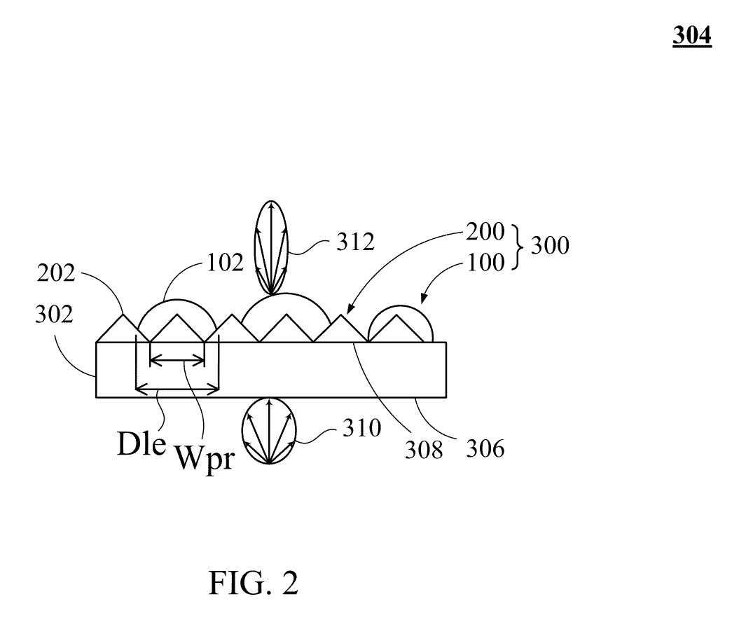

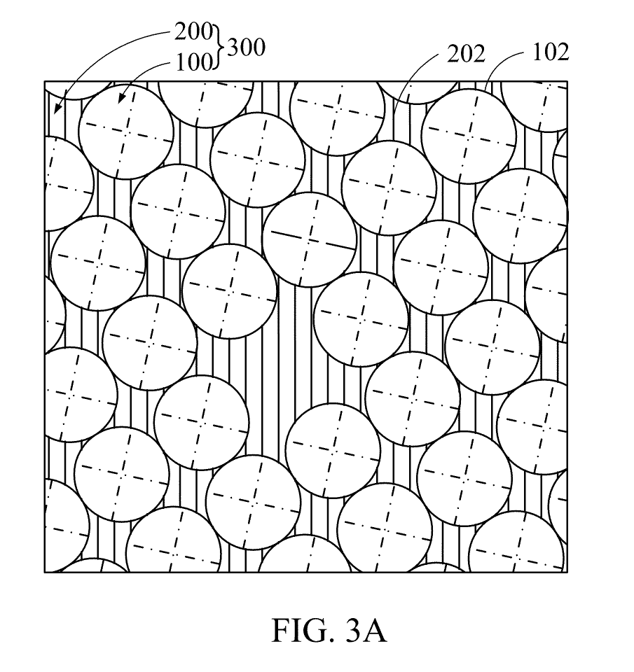

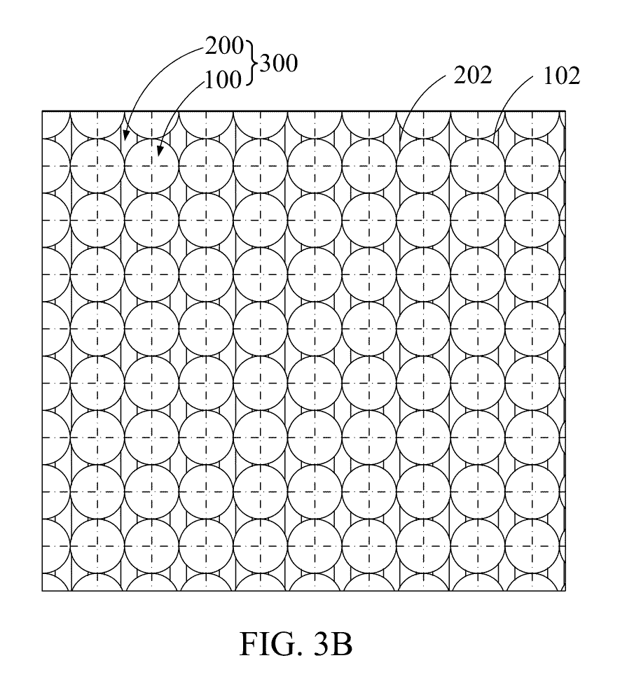

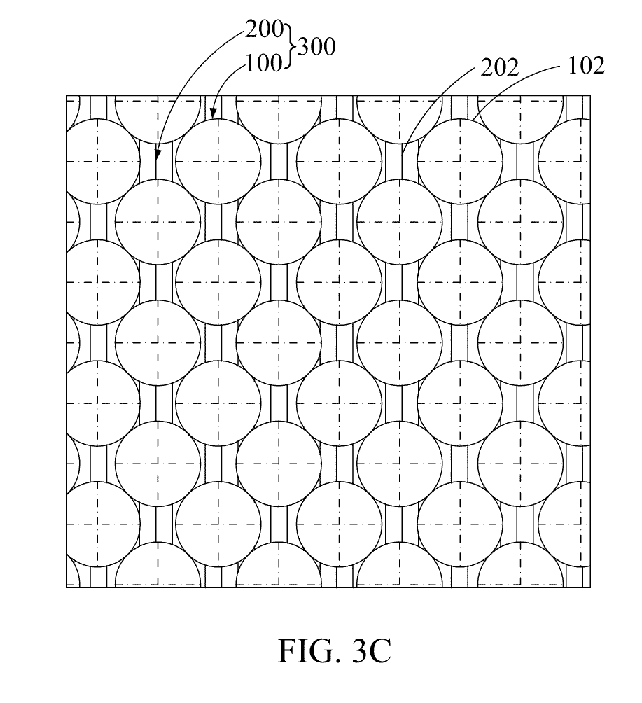

Please refer to FIG. 2 and FIG. 3A. FIG. 2 is a schematic cross-sectional view of a composite structure layer 300 having a lens-type layer 100 and a prism-type layer 200 according to one embodiment of the present invention. FIG. 3A is a schematic plan view of a composite structure layer 300 having a lens-type layer 100 and a prism-type layer 200 according to a first embodiment of the present invention. The composite structure layer 300 includes a lens-type layer 100 and a prism-type layer 200. The composite structure layer 300 is applicable to light module of display system, e.g. desktop monitor, portable monitor, or liquid crystal display (LCD) TV monitor. As shown in FIG. 2, the brightness enhancement film 304 having a composite lens and prism structure includes a substrate layer 302 and a composite structure layer 300. The substrate layer 302 has an optical incident surface 306 and an optical emission surface 308. The composite structure layer 300 is positioned on the optical emission surface 308 of the substrate layer 302 and has a lens-type layer 100 and a prism-type layer 200. The lens-type layer 100 has a plurality of protrusion units 102 and the prism-type layer 200 has a plurality of prismatic units 202. The protrusion units 102 are uniformly arranged among the prismatic units 202, and an area ratio of the region of the protrusion units 102 to the region of the prismatic units 202 based on a predetermined unit area of the composite structure layer 300 can be changed for adjusting an convergent angle when a light beam 310 penetrates through the composite structure layer 300 via the optical emission surface 308 of the substrate layer 302 to generate the emitted light beam 312. The emitted light beam 312 concentrates on the view field of the user. In the present invention, the lens-type layer 100 and the prism-type layer 200 are positioned in the same material layer and the protrusion units 102 are uniformly arranged among the prismatic units 202.

In one embodiment, the protrusion units 102 of the lens-type layer 100 are uniformly arranged among the prismatic units 202 of the prism-type layer 200 in an irregular status. The irregular status means that the protrusion units 102 are haphazardly distributed among the prismatic units 202. In other words, the protrusion units 102 have random arrangement intensity. For example, the arrangement between the protrusion units 102 and the prismatic units 202 is non-repetitive. As shown in FIG. 3A, each of the protrusion units 102 has a spacing interval therebetween for randomly arranging the protrusion units 102 among the prismatic units 202 of the prism-type layer 200.

In another embodiment, the protrusion units 102 of the lens-type layer 100 are uniformly arranged among the prismatic units 202 of the prism-type layer 200 in a regular status. The regular status means that the protrusion units 102 are uniformly distributed among the prismatic units 202, wherein the protrusion units 102 and the prismatic units 202 may be regular or irregular shape for manufacturing their shapes, such as using a cutting process. FIG. 3B is a schematic plan view of a composite structure layer 300 having a lens-type layer 100 and a prism-type layer 200 according to a second embodiment of the present invention. FIG. 3C is a schematic plan view of a composite structure layer 300 having a lens-type layer 100 and a prism-type layer 200 according to a third embodiment of the present invention. As shown in FIG. 3B, the protrusion units 102 mutually connected or overlapped, or have spacing interval, and the protrusion units 102 of the lens-type layer 100 are in form of a quadrangle pattern. As shown in FIG. 3C, the protrusion units 102 mutually connected or overlapped, or have spacing interval, and the protrusion units 102 of the lens-type layer 100 are in form of a hexagonal pattern.

Specifically, the area ratio of the region of the protrusion units 102 to the region of the prismatic units 202 is either equal to or greater than one so that the total region of the protrusion units 102 are either equal to or greater than the total region of the prismatic units 202 on the substrate layer 302.

According to the above-mentioned descriptions, the protrusion units 102 are uniformly arranged among the prismatic units 202, and an area ratio of the region of the protrusion units 102 to the region of the prismatic units 202 based on a predetermined unit area of the composite structure layer 300 can be changed for adjusting an convergent angle when a light beam 310 penetrates through the composite structure layer 300. Therefore, the problems of moire pattern, rainbow pattern, and dark lines are solved.

The heights of the protrusion units 102 are different from the heights of the prismatic units 202. Preferably, the heights of the protrusion units 102 are greater than the heights of the prismatic units 202. Since the heights of the protrusion units 102 are greater than the heights of the prismatic units 202, the light leakage of the brightness enhancement film resulting from the moisture in the recess between two prismatic units 202 can be avoided advantageously. That is, the space between the lens-type layer 100 and the prism-type layer 200 becomes larger so that the moisture cannot fill in the space completely. In addition, when the heights of the protrusion units 102 are greater than the heights of the prismatic units 202, the prismatic units 202 cannot scratch other contacted material layer.

Please refer to FIGS. 2 and 3A continuously. Each of the protrusion units 102 are arranged among the prismatic units 202 in an asymmetric status or a symmetric status. In this case, the protrusion unit 102 is a semi-circular spheroid and the prismatic unit 202 is a triangular shape. The diameter “Dₗₑ” of semi-circular spheroid is greater than the base width “Wₚᵣ” of the triangular shape. The axial is 12 degree relative to the vertical direction or ranges from 0 to 90 degrees. In one embodiment, the spacing interval of the protrusion unit 102 has a range from 50 μm to 120 μm and the spacing interval of the prismatic unit 202 has a range from 5 μm to 70 μm.

While making the composite structure layer by roll-to-roll mold, the bubbles generated by the extrusion of the mold can be effectively removed from the recess between the prismatic units 202 to increase the yield rate of the brightness enhancement film.

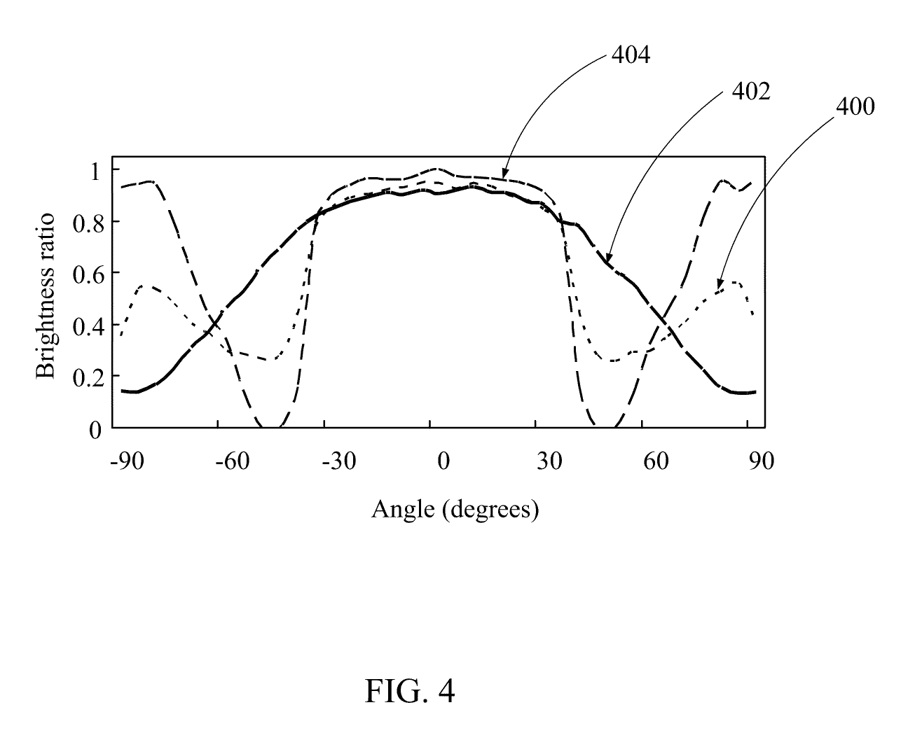

Please refer to FIG. 2 and FIG. 4. FIG. 4 is a schematic waveform of brightness percentage to convergent angle along the vertical direction of the composite structure layer 300 according to one embodiment of the present invention. The horizontal axis represents the convergent angle of the brightness enhancement film. The positive value of the convergent angle is defined from front side of the user to the right side and the negative value of the convergent angle is defined from front side of the user to the left side. The vertical axis represents the brightness percentage which is relative to 100%. The waveform in FIG. 4 includes a proposed brightness curve for composite structure layer 400, a conventional brightness curve for lens layer 402, and a conventional brightness curve for prism layer 404. The proposed brightness curve for composite structure layer 400 is a relationship curve between brightness percentage along vertical direction and convergent angle when the light beam penetrates through the composite structure layer 300 of the brightness enhancement film. The conventional brightness curve for lens layer 402 is a relationship curve between brightness percentage along vertical direction and convergent angle when the light beam penetrates through a single layer of lenses on the substrate layer of the conventional brightness enhancement film. The conventional brightness curve for prism layer 404 is a relationship curve between brightness percentage along vertical direction and convergent angle when the light beam penetrates through a single layer of prisms on the substrate layer of the conventional brightness enhancement film.

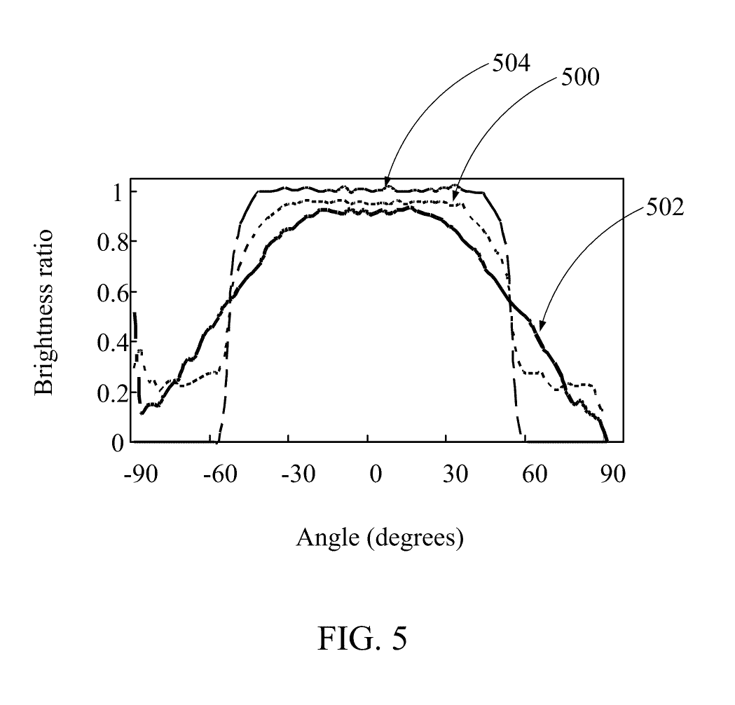

FIG. 5 is a schematic waveform of brightness percentage to convergent angle along the horizontal direction of the composite structure layer 300 according to one embodiment of the present invention. The horizontal axis represents the convergent angle of the brightness enhancement film. The vertical axis represents the brightness percentage. The waveform in FIG. 5 includes a proposed brightness curve for composite structure layer 500, a conventional brightness curve for lens layer 502, and a conventional brightness curve for prism layer 504. The proposed brightness curve for composite structure layer 500 is a relationship curve between brightness percentage along horizontal direction and convergent angle when the light beam penetrates through the composite structure layer 300 of the brightness enhancement film. The conventional brightness curve for lens layer 502 is a relationship curve between brightness percentage along horizontal direction and convergent angle when the light beam penetrates through a single layer of lenses on the substrate layer of the conventional brightness enhancement film. The conventional brightness curve for prism layer 504 is a relationship curve between brightness percentage along horizontal direction and convergent angle when the light beam penetrates through a single layer of prisms on the substrate layer of the conventional brightness enhancement film.

As shown in FIG. 4 and FIG. 5, the convergent angle of the conventional brightness curve for lens layer 402 is the same as the convergent angle of the conventional brightness curve for lens layer 502. The convergent angle is symmetric. In other words, if the convergent angle along vertical direction is decreased, the convergent angle along horizontal direction is also reduced, thereby resulting in no design flexibility for brightness enhancement film (BEF). The conventional brightness curve for prism layer 404 is less than the conventional brightness curve for prism layer 504 all the time, thereby resulting in no design flexibility for the BEF. The convergent angles of the proposed brightness curve for composite structure layer 400, 500 along vertical and horizontal directions can be adjusted by modifying the area ratio between protrusion units 102 of the lens-type layer and the prismatic units 202 of the prism-type layer 200 so that the light beam is concentrated on front side of the user to flexibly control the convergent angle of the light beam. For example, if the convergent angle along the horizontal direction requires to be decreased, the area ratio of the protrusion units 102 is increased. If the convergent angle along the horizontal direction requires to be increased, the area ratio of the protrusion units 102 is decreased. The BEF having a composite lens and prism structure improves the design flexibility for the BEF.

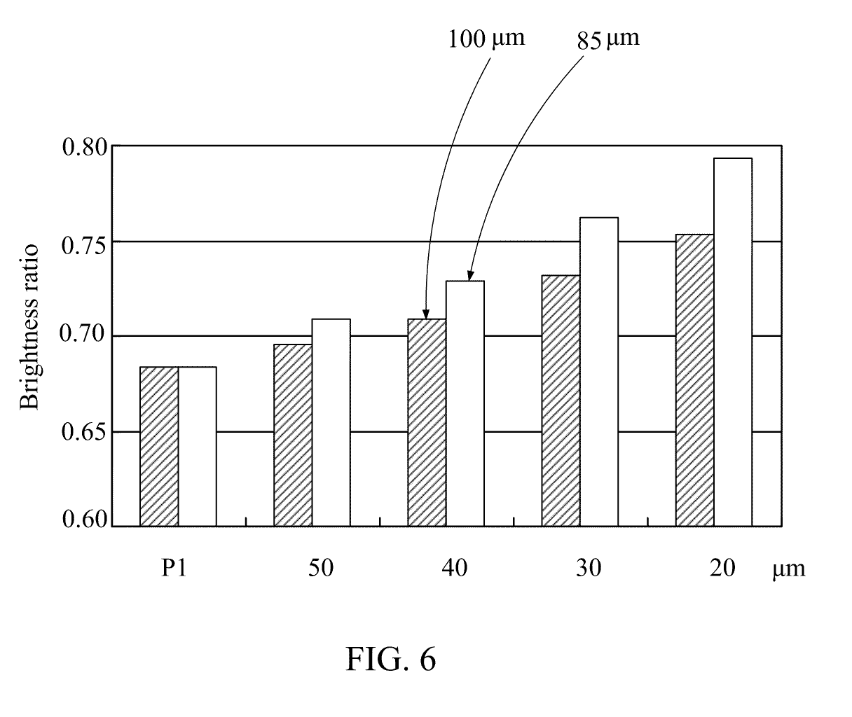

FIG. 6 is a schematic waveform of average brightness of the composite structure layer 300 having a lens-type layer 100 and a prism-type layer 200 according to one embodiment of the present invention. The bar charts with blanks represent the spacing interval 85 μm of the protrusion units 102 and the bar charts with section lines represent the spacing interval 100 μm of the protrusion units 102. The horizontal axis represents the base widths 20 μm, 30 μm, 40 μm, and 50 μm of the prismatic units 202 of the prism-type layer 200. “P1” is the base width of the conventional prism. The vertical axis represents the brightness percentage. For an example of 100 degrees of the convergent angle, when the protrusion units 102 are arranged among the prismatic units 202, the brightness percentage of the composite structure layer 300 is greater than the brightness percentage of the conventional prism at “P1” of the base width. Further, the brightness percentage of the spacing interval 85 μm is greater than that of the spacing interval 100 μm. Additionally, when the base widths of the prismatic units 202 raise, the brightness percentage is increased. Therefore, the composite structure layer 300 in the present invention can effectively adjust the brightness of the BEF.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A brightness enhancement film having a composite lens and prism structure, the brightness enhancement film comprising:
a substrate layer having an optical incident surface and an optical emission surface;
a composite structure layer positioned on the optical emission surface of the substrate layer and having a lens-type layer and a prism-type layer, wherein the lens-type layer has a plurality of protrusion units and the prism-type layer has a plurality of prismatic units, and wherein the protrusion units are uniformly arranged among the prismatic units, and an area ratio of the region of the protrusion units to the region of the prismatic units based on a predetermined unit area of the composite structure layer can be changed for adjusting an convergent angle when a light beam penetrates through the composite structure layer via the optical emission surface of the substrate layer.

2. The brightness enhancement film of claim 1, wherein the protrusion units of the lens-type layer is selected from one group consisting of a semi-circular spheroid, a semi-oval spheroid, and a semi-cone spheroid.

3. The brightness enhancement film of claim 1, wherein the prismatic units of the prism-type layer are a plurality of three-dimensional structure by dragging a plurality of prismatic cross-sections along the substrate layer thereon.

4. The brightness enhancement film of claim 3, wherein each of the prismatic cross-sections is selected from a triangular shape, a semi-circular shape, a semi-oval shape, and a semi-cone shape.

5. The brightness enhancement film of claim 1, wherein the protrusion units of the lens-type layer are uniformly arranged among the prismatic units of the prism-type layer in an irregular status, and each of the protrusion units has a spacing interval therebetween for randomly arranging the protrusion units among the prismatic units of the prism-type layer.

6. The brightness enhancement film of claim 1, wherein the protrusion units of the lens-type layer are uniformly arranged among the prismatic units of the prism-type layer in a regular status.

7. The brightness enhancement film of claim 6, wherein the protrusion units of the lens-type layer are in form of either a quadrangle pattern or a hexagonal pattern.

8. The brightness enhancement film of claim 1, wherein each of the protrusion units are connected one another and the connected protrusion units are in form of an interlaced pattern.

9. The brightness enhancement film of claim 1, wherein the height of the protrusion units are greater than the height of the prismatic units.

10. The brightness enhancement film of claim 1, wherein the area ratio of the region of the protrusion units to the region of the prismatic units is either equal to or greater than one so that the total region of the protrusion units are either equal to or greater than the total region of the prismatic units on the substrate layer.

11. A brightness enhancement film having a composite lens and prism structure, which is applicable to a display system, the brightness enhancement film comprising:
a substrate layer having an optical incident surface and an optical emission surface;
a composite structure layer positioned on the optical emission surface of the substrate layer and having a lens-type layer and a prism-type layer, wherein the lens-type layer has a plurality of protrusion units and the prism-type layer has a plurality of prismatic units, and wherein the protrusion units are uniformly arranged among the prismatic units for adjusting an convergent angle when a light beam penetrates through the composite structure layer via the optical emission surface of the substrate layer.

12. The brightness enhancement film of claim 11, wherein the protrusion units of the lens-type layer is selected from one group consisting of a semi-circular spheroid, a semi-oval spheroid, and a semi-cone spheroid.

13. The brightness enhancement film of claim 11, wherein the prismatic units of the prism-type layer are a plurality of three-dimensional structure by dragging a plurality of prismatic cross-sections along the substrate layer thereon.

14. The brightness enhancement film of claim 13, wherein each of the prismatic cross-sections is selected from a triangular shape, a semi-circular shape, a semi-oval shape, and a semi-cone shape.

15. The brightness enhancement film of claim 11, wherein the protrusion units of the lens-type layer are uniformly arranged among the prismatic units of the prism-type layer in an irregular status, and each of the protrusion units has a spacing interval therebetween for randomly arranging the protrusion units among the prismatic units of the prism-type layer.

16. The brightness enhancement film of claim 11, wherein the protrusion units of the lens-type layer are uniformly arranged among the prismatic units of the prism-type layer in a regular status.

17. The brightness enhancement film of claim 16, wherein the protrusion units of the lens-type layer are in form of either a quadrangle pattern or a hexagonal pattern.

18. The brightness enhancement film of claim 11, wherein each of the protrusion units are connected one another and the connected protrusion units are in form of an interlaced pattern.

19. The brightness enhancement film of claim 11, wherein the height of the protrusion units are greater than the height of the prismatic units.

20. The brightness enhancement film of claim 11, wherein the area ratio of the region of the protrusion units to the region of the prismatic units is either equal to or greater than one so that the total region of the protrusion units are either equal to or greater than the total region of the prismatic units on the substrate layer.
